(19) United States
(12) Patent Application Publication
(10) Pub. No.: US 2007/0263815 A1
(43) Pub. Date: Nov. 15, 2007

(54) SYSTEM AND METHOD FOR COMMUNICATION PROVISION

(76) Inventor: Mikko A. Nurmi, Tampere (FI)

Correspondence Address: MORGAN & FINNEGAN, L.L.P., 3 WORLD FINANCIAL CENTER, NEW YORK, NY, 10281-2101, US

(21) Appl. No.: 11/379,257

(22) Filed: Apr. 19, 2006

(51) Int. Cl. H04M 3/42

(52) U.S. Cl. 379/201.01

(57) ABSTRACT

Systems and methods applicable, for instance, in communication provision. A user might, for example, be able to indicate a desire to receive live calls from one or more parties. A party wishing to place a live call to interested users might, for example, be able to place a call to a particular telephone number. One or more devices receiving such a call might, for instance, act to establish a live call from the party to one or more interested users.

### FIELD OF INVENTION

This invention relates to systems and methods for communication provision.

### BACKGROUND INFORMATION

In recent times, there has been an increase in desire to communicate information. For example, many parties have increasingly found themselves wanting to communicate information (e.g., regarding their music and/or movies) to interested individuals. Moreover, many parties have found themselves wanting further ways for doing so.

Accordingly, there may be interest in technologies that facilitate such communication.

### SUMMARY 0F THE INVENTION

According to embodiments of the present invention, there are provided systems and methods applicable, for instance, in communication provision.

For example, in various embodiments a user might be able to indicate a desire to receive live calls from one or more parties.

A party wishing to place a live call to interested users might, in various embodiments, be able to place a call to a particular telephone number. One or more devices receiving such a call might, in various embodiments, act to establish a live call from the party to one or more interested users.

### BRIEF DESCRIPTION OF THE DRAWINGS

FIG. 1 shows exemplary steps involved in setup operations according to various embodiments of the present invention.

FIG. 2 shows exemplary steps involved in call operations according to various embodiments of the present invention.

FIG. 3 shows exemplary steps involved in additional operations according to various embodiments of the present invention.

FIG. 4 shows an exemplary computer.

FIG. 5 shows a further exemplary computer.

### DETAILED DESCRIPTION OF THE INVENTION

General Operation

According to embodiments of the present invention, there are provided systems and methods applicable, for instance, in communication provision.

For example, in various embodiments a user might be able to indicate a desire to receive live calls (e.g., telephone calls) from one or more parties. It is noted that, in various embodiments, such live calls might be live one-way calls and/or live two-way calls. It is further noted that, in various embodiments, such live calls might be voice calls and/or video calls.

A party wishing to place a live call (e.g., a live one-way call or a live two-way call) to interested users might, in various embodiments, be able to place a call to a particular telephone number. Such a telephone number might, in various embodiments, be answered by one or more devices (e.g., one or more servers).

One or more devices receiving such a call might, in various embodiments, act to determine users that are interested in receiving calls from the party. Moreover, in various embodiments, the one or more devices might establish a live call (e.g., a live one-way call or a live two-way call) from the party to one or more of the interested users. The interested users might, in various embodiments, receive caller identification indicating the party.

The interested users might, in various embodiments, be provided with one or more items and/or one or more links corresponding to the call from the party.

Moreover, in various embodiments, a user that missed a call for establishing the live call from the party might receive a message (e.g., a voice message) and/or might be able to call a telephone number to be connected with the live call from the party.

Various aspects of the present invention will now be discussed in greater detail.

Setup Operations

It is noted that, according to various embodiments of the present invention, a user might be able to indicate a desire to receive live calls (e.g., live one-way calls and/or live two-way calls) from one or more parties. Such functionality might be implemented in a number of ways.

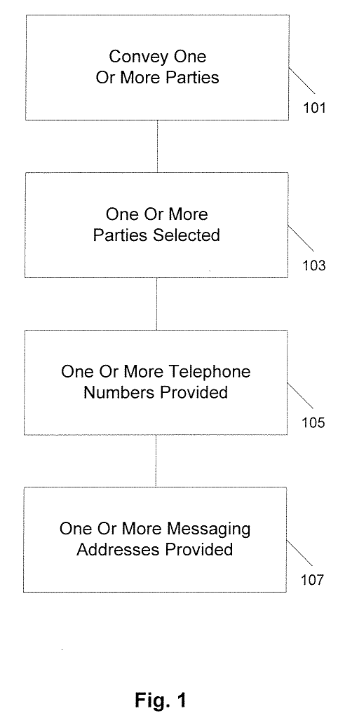

With respect to FIG. 1 it is noted that the user's telephone and/or wireless node and/or other computer might, for example, present the user with a Graphical User Interface (GUI) and/or other interface conveying to the user one or more parties that have chosen to provide live calls (e.g., live one-way calls and/or live two-way calls) to users (step 101). Such parties might, for instance, be celebrities, musicians, actors, athletes, writers, directors, artists, hosts, corporate leaders, and/or advertisers. Such a GUI and/or other interface might, for example, be provided in conjunction with a web browser that has been directed to a particular website. As another example, such a GUI and/or other interface might be provided in conjunction with client software running at and/or remote from the user's telephone and/or wireless node and/or other computer.

Such a website might, for instance, be provided by one or more devices (e.g., one or more servers). Such client software might, for instance, be in communication with one or more devices (e.g., one or more servers). Communication with one or more devices providing such a website, and/or between such client software and one or more devices to be communicated with by the client software might be implemented in a number of ways. For example, Hypertext Transfer Protocol (HTTP), Remote Method Invocation (RMI), Java Messaging Service (JMS), Simple Object Access Protocol (SOAP), Object Exchange (OBEX) Object Push Profile (OPP), email, Multimedia Messaging Service (MMS), Short Message Service (SMS), Universal Mobile Telecommunications Service (UMTS), General Packet Radio Service (GPRS), Bluetooth, wireless local area network (e.g., WiFi (Wireless Fidelity)), Ultra Wide Band (UWB), Worldwide Interoperability for Microwave Access (WiMax), IrDA (Infrared Data Association), wired network (e.g., Ethernet), and/or the Internet might be employed. Such WiFi might, for instance, be IEEE 802.11b and/or IEEE 802.11g. Such WiMax might, for instance, be IEEE 802.16e.

The user might, for example, be able to provide via the GUI and/or other interface selection of one or more conveyed parties as being ones from whom she desires to receive live calls (step 103). As another example, the user might be able to provide via the GUI and/or other interface one or more telephone numbers at which she whishes to receive live calls from selected parties (step 105), one or more messaging addresses (e.g., email, instant messaging, SMS, and/or MMS addresses) at which she wishes to receive dispatches from selected parties (step 107), details regarding the user's telephone and/or wireless node and/or other computer (e.g., device type and/or capabilities specification), and/or information relating to charges associated with receiving live calls from parties (e.g., the user might provide billing information). It is noted that, in various embodiments, a messaging address might be a telephone number.

Such details regarding the user's telephone and/or wireless node and/or other computer might, in various embodiments, include specification regarding display capabilities, voice communication capabilities, video communication capabilities, and/or ability to receive various messages (e.g., email, instant messaging, SMS, and/or MMS messages). It is noted that, in various embodiments the user might be able to specify one or more provided telephone numbers as being preferred telephone numbers, might be able to specify one or more provided messaging addresses as being preferred messaging addresses, and/or might be able to specify one or more ways of receiving dispatches as being preferred ways (e.g., the user might be able to specify one or more of email, instant messaging, SMS, and/or MMS as preferred ways of receiving dispatches).

In various embodiments, users might not be charged for live calls from parties and/or might not be specifically charged for live calls from parties (e.g., users might only be charged as they would for any normal incoming call). It is further noted that, in various embodiments, the user might be able to specify various information in a party-specific manner. For instance, the user might be able to specify that live calls from a first selected party be received at a first telephone number, that dispatches from the first selected party be received at a first messaging address, that live calls from a second selected party be received at a second telephone number, and/or that dispatches from the second selected party be received at a second messaging address.

User-provided information (e.g., party specification) might, for instance, come to be possessed by one or more devices. Such one or more devices might, for example, include one or more devices of the sort discussed above providing a website, one or more devices of the sort discussed above with which client software communicates, and/or one or more other devices (e.g., one or more servers). It is noted that, in various embodiments, such one or more other devices might come to posses such user-provided information via communication with one or more devices of the sort discussed above providing a website, and/or with one or more devices of the sort discussed above with which client software communicates. Communication by which such one or more other devices come to posses such user-provided information might, for example, be implemented in a manner analogous to that discussed above (e.g., SOAP and/or JMS might be employed).

As another example of functionality for indicating a desire to receive live calls from one or more parties, a user might be able to indicate such desire via messaging (e.g., email, instant messaging, SMS, and/or MMS). Via such messaging, the user might, in various embodiments, be able to provide various corresponding information (e.g., of the sort discussed above). Such functionality might be implemented in a number of ways. For example the user might dispatch messaging (e.g., an email, instant messaging, SMS, and/or MMS message) to a particular messaging address (e.g., an email address, instant messaging address, SMS address, and/or MMS address). Such a messaging address might, for instance, be one established for receiving messaging from users desiring (e.g., via subscribing to one or more services) to receive live calls from parties.

Such messaging might, for example, specify one or more parties as being ones from whom she desires to receive live calls (e.g., such might be specified in the body of a dispatched message). As another example, such messaging might not include specification of one or more parties from whom the user desires to receive live calls, and instead might convey one or more desired parties by virtue of the messaging address to which it is dispatched. For example, a particular messaging address corresponding to a particular party might be established, and any message dispatched to that address might be interpreted as the sender of that messaging indicating a desire to receive live calls from that party.

Where messaging is employed for specification of parties from whom receipt of live calls is desired, the one or more telephone numbers to which such calls should be directed and/or the one or more messaging addresses to which dispatches should be sent could be determined in a number of ways. For example, a dispatched message seeking receipt of live calls from one or more parties might, perhaps in its body, specify such telephone numbers and/or messaging addresses. As another example, live party calls and/or dispatches might be directed to the source from which messaging seeking live calls from parties was dispatched (e.g., the telephone number and/or messaging address). For instance, in the case where messaging seeking live calls from parties was an SMS message sent from a particular telephone number, that telephone number might be considered to be the one to which live calls from one or more parties should be directed.

It is noted that, in various embodiments, it might be possible to provide, via messaging, information relating to charges associated with receiving live calls from parties (e.g., of the sort discussed above). Such information might be provided in a number of ways. For instance, such information might be included in one or more dispatched messages (e.g., via message body). As indicated above, in various embodiments users might not be charged for live calls from parties and/or might not be specifically charged for live calls from parties. It is additionally noted that, in various embodiments, users might, perhaps in a manner analogous to that discussed above, be able to specify various information in a party-specific manner. Such might, for example, be achieved by specifying, via inclusion in one or more dispatched messages (e.g., via message body), indicated information (e.g., telephone number for call receipt) as being specific to one or more parties. As another example, information indicating via message dispatch might be considered to correspond to a particular party by virtue of the messaging address to which the message was dispatched. For instance, indicated information conveyed via messaging directed to a particular messaging address corresponding to a particular party might be interpreted as information corresponding to that party.

Messaging seeking live calls from parties and/or information conveyed thereby might, in various embodiments, come to be possessed by one or more devices (e.g., one or more servers). Such one or more devices might, for instance, be one or more devices configured to receive such messages (e.g., configured to receive messaging directed to one or more messaging addresses established for receiving message from users desiring to receive live calls from parties), and/or one or more other devices (e.g., one or more servers). Such other devices might, for example, come to possess such messaging and/or information conveyed thereby via communication with the one or more devices configured to receive such messages. Such communication might, for example, be performed in a manner analogous to that discussed above (e.g., SOAP and/or JMS might be employed).

As yet another example of functionality for indicating a desire to receive live calls from one or more parties, a user might be able to place one or more voice calls to one or more telephone numbers established to be called by users desiring to receive live calls from parties. Via such voice calls, the user might, in various embodiments, be able to provide various corresponding information (e.g., of the sort discussed above). It is noted that, in various embodiments, one or more telephone numbers corresponding to particular parties might be established (e.g., a telephone number might be established to be called by users desiring to receive live calls from a particular party).

A user calling a telephone number established to be called by users desiring to receive live calls from parties might, for instance, receive voice prompts informing the user of one or more parties that have chosen to provide live calls. The user might, perhaps via pressing of telephone keys and/or by speaking, be able to specify one or more parties from whom the user desires to receive live calls, specify one or more telephone numbers to which live calls from parties should directed, one or more messaging addresses to which dispatches from selected parties should be directed, and/or information relating to charges associated with receiving live calls from parties (e.g., of the sort discussed above). As indicated above, in various embodiments users might not be charged for live calls from parties and/or might not be specifically charged for live calls from parties.

Calls seeking live calls from parties and/or information conveyed thereby might, in various embodiments, come to be possessed by one or more devices (e.g., one or more servers) configured to receive calls from users desiring to receive live calls from parties (e.g., devices that provide the above-discussed voice prompts, and/or that receive the above-discussed user provision of information), and/or by one or more other devices. Such other devices might, for example, come to possess such live calls and/or information conveyed thereby via communication with the one or more devices configured to receive the calls from users. Such communication might, for example, be performed in a manner analogous to that discussed above.

As further examples, a user might be able to indicate a desire to receive live calls from parties and/or provide information corresponding thereto (e.g., of the sort discussed above) in person (e.g., by visiting an employee at a store or kiosk) and/or via conventional mail.

It is noted that, in various embodiments, one or more authentication operations might be performed with respect to a user indicating a desire to receive live calls from one or more parties. Such operations might, for instance, be performed by one or more devices of the sort discussed above, by one or more other devices, and/or by one or more individuals (e.g., employees of the sort discussed above). Such authentication operations might, for instance, be employed to prevent a user from making it seem as if a second user wished to receive live calls from one or more parties (e.g., where the second user did not actually desire to receive such calls).

It is noted that, in various embodiments, receiving calls from parties might be offered to users as one or more services, and/or a user indicting a desire to receive live calls from one or more parties might involve the user subscribing to a service.

According to various embodiments of the present invention, a party might be able to indicate a desire to provide live calls (e.g., live one-way calls and/or live two-way calls) to users. Such functionality might be implemented in a number of ways.

For example, GUI and/or other interface functionality, messaging functionality, voice telephone number functionality, in-person functionality, and/or conventional mail functionality might, perhaps in a manner analogous to that discussed above, act so as to allow parties to indicate such desire and/or to provide corresponding information.

Such corresponding information might, for example, include indication regarding fees to be charged for live call receipt by users (e.g., indication of one or more particular fees to be charged and/or indication that no specific fees are to be charged). As another example, such corresponding information might include indication regarding presentation such as, for instance, how the party's name should be conveyed, format of one or more GUIs and/or other interfaces allowing users to choose to receive live calls form the party, and/or one or more messages to be played to users before start of the party speaking on a live call.

As yet another example, such corresponding information might include indication regarding various rules. Such rules might, for instance include minimum age for users receiving calls from the party, region restrictions regarding users that may receive calls from the party, and/or affiliation restrictions regarding users that may receive calls from the party (e.g., that users must own specified products, be members of specified groups, and/or must subscribe to specified services).

A further example, such corresponding information might include indication regarding one or more sources of items (e.g., items discussed during live calls). Such items might, for instance, include physical items and/or non-physical items (e.g., digital items). Such non-physical items might, for example, include audio (e.g., music), still images, moving images (e.g., television shows, movies, and/or music videos), and/or software (e.g., games). Such physical items might, for instance, include party-related items (e.g., clothing, posters, and/or souvenirs). Such sources might, for instance, include physical stores and/or online stores. Such online stores might, for example, be ones allowing item download.

As yet another example, such corresponding information might include specification of one or more telephone numbers from which the party will initiate live calls to users, one or more pass codes, and/or voice sample submission (e.g., to be employed for voiceprint production).

It is noted that, in various embodiments, a party that has indicated a desire to provide live calls to users might be able indicate (e.g., via GUI and/or other interface functionality, messaging functionality, voice telephone number functionality, in-person functionality, and/or conventional mail functionality) one or more of groups of users as groups to which she will provide live calls. The party might, in various embodiments, be informed (e.g., via GUI and/or other interface functionality, messaging functionality, voice telephone number functionality, in-person functionality, and/or conventional mail functionality) of one or more already-defined groups of users. Alternately or additionally, in various embodiments the party might be able to formulate one or more such groups (e.g., via GUI and/or other interface functionality, messaging functionality, voice telephone number functionality, in-person functionality, and/or conventional mail functionality). It is noted that, in various embodiments, such already-defined groups might have been formulated, for instance, by advertising agencies, service providers, content providers (e.g., record companies, television studios, and/or movie studios), and/or manufactures (e.g., device manufacturers).

Groups of users (e.g., already-defined groups) might, for example, include users matching various demographics, users with certain interests, users that have made certain purchases, users that own certain items (e.g., physical items and/or non-physical items), and/or users that have agreed to receive live calls from parties. Such users that have agreed to receive live calls from parties might, in various embodiments, have done so with provision of one or more stipulations. To illustrate by way of example, such users might have agreed to receive live calls regarding particular purchases that they made, live calls regarding certain interests that they have, and/or live calls certain sorts of parties (e.g., musicians and/or actors).

It is further noted that, in various embodiments, a party that has indicated a desire to provide live calls to users might receive one or more telephone numbers. Such telephone numbers might, for instance, include one or more telephone numbers callable by the party when she wishes to provide a live call to users. Such telephone numbers might, for instance, be conveyed to the party in a manner analogous to that discussed above. For instance, such telephone numbers might be conveyed to the party via GUI and/or other interface, messaging, via call, in person, and/or via conventional mail.

One or more authentication operations might, in various embodiments, be performed with respect to a party indicating a desire to provide live calls to users. Such authentication operations might, for instance, be performed in a manner analogous to that discussed above. Such authentication operations might, for example, be employed to prevent an individual from impersonating a party.

It is noted that, in various embodiments, a party indicting a desire to provide live calls to users might involve the party subscribing to a service (e.g., a marketing service).

It is further noted that, in various embodiments, authentication of parties might be required even if authentication of users indicating desire to receive live calls from one or more parties is not.

It is also noted that, in various embodiments, some or all of the devices discussed above might include and/or be in communication with call (e.g., telephone call) and/or messaging interface software and/or hardware. Such hardware and/or software might, for instance, include hardware and/or software capable of touch tone recognition, speech recognition, speech synthesis, and/or textual analysis.

It is additionally noted that, in various embodiments, a user might, perhaps in a manner analogous to that discussed above, be able to indicate that she no longer wishes to receive live calls from one or more parties.

Call Operations

One or more users might, according to various embodiments of the present invention, be provided with a live call (e.g., a live one-way call or a live two-way call) from a party. Such a call might, for instance, be received by a user's telephone and/or wireless node and/or other computer. Such functionality might be implemented in a number of ways.

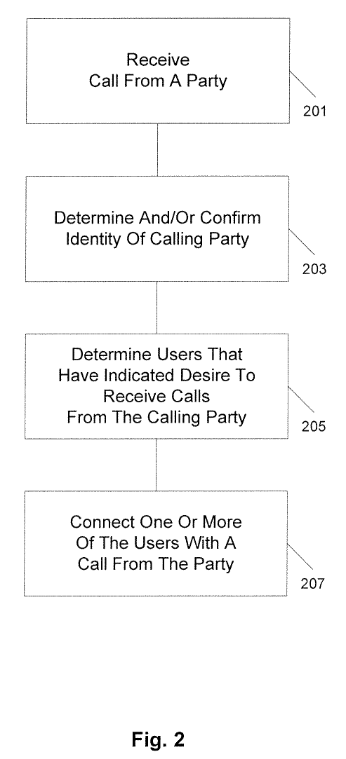

With respect to FIG. 2 it is noted that, for example, in various embodiments one or more devices (e.g., one or more servers) might receive a call from a party (step 201). Such a call might, for instance, be directed to a telephone number of the sort discussed above provided to the party in connection with that party indicating a desire to provide live calls to users. Such one or more devices might, in various embodiments, be devices that perform, and/or might be in communication with one or more devices that perform, one or more of the operations discussed above with respect to users indicating desire to receive live calls from one or more parties, and/or parties indicating desire to provide live calls to users. Such communications might, for example, be implemented in a manner analogous to that discussed above. It is noted that, in various embodiments, such one or more devices might include and/or be in communication with call and/or messaging interface software and/or hardware of the sort discussed above.

Receiving such a call from the party, the one or more devices might, in various embodiments, perform one or more operations.

For example, the one or more devices might act to determine and/or confirm the identity of the calling party(step 203). Such functionality might be implemented in a number of ways. For example, the telephone number from which the call was placed might be determined and compared with a listing of party telephone numbers in an accessible store. Telephone number determination might, for instance, involve use of Caller Identity Display (Caller ID) and/or Automatic Number Identification (ANI). Such an accessible store might, for instance, be populated with numbers specified by parties as discussed above. As another example, the number called by the party might be considered (e.g., in a manner including consultation of an accessible store). For instance, certain telephone numbers might be reserved for one or more specific parties. As yet another example, the calling party might, perhaps in response to a query provided by the one or more devices (e.g., via voice synthesis), offer a pass code (e.g., via touchtone entry and/or via voice) and/or a voice sample. Such a pass code and/or voice sample might, for instance, be employed in consulting an accessible store. Such an accessible store might, for instance, be populated in accordance with specification by parties as discussed above.

As another example, the one or more devices receiving the call from the party might, perhaps via consultation of one or more accessible stores, determine the users that have indicated desire to receive live calls from the calling party (step 205), and/or one or more telephone numbers specified by those users as being ones at which they want to receive live calls from the party. Such accessible stores might, for instance, be populated as discussed above.

As yet another example, the one or more devices receiving the call from the party might act to connect one or more of the users that have indicated desire to receive live calls from the party with a live call (e.g., a live one-way call or a live two-way call) from the party (step 207). The one or more devices might, for instance, establish a telephonic audio link between the party and the users. Such a telephonic audio link might, in various embodiments be a one-way audio link from the party such that, for instance, users can hear the party but not respond to her. Such a one-way audio link might, for instance, be employed where the live call is a live one-way call. It is noted that, in various embodiments, party calls might be provided such that a called user feels as if she is receiving a personal call from the corresponding party. It is noted that, in various embodiments, party calls might be multicast calls.

In various embodiments, the one or more devices connecting a user to the live call from the party might involve the one or more devices placing calls to one or more of the users that have that have indicated desire to receive live calls from the party. A user answering such a call might, for instance, be connected to the live call from the party. It is noted that, in various embodiments, placement of such calls to users might be implemented in a manner such that the users are receive caller identification indicating the party. For instance, a telephone and/or wireless node and/or other computer of such a user might, while ringing, display to the user (e.g., via Caller ID) caller identification showing the name of the party and/or a telephone number. It is noted that, in various embodiments, a call placed to such a displayed telephone number might be answered by one or more staff members of the party, and/or might be directed to one or more call centers. Such staff members might, in various embodiments, be affiliated with one or more such call centers. In various embodiments, direction to a call center of a call placed to such a displayed telephone number might involve one or more devices (e.g., of the sort discussed herein) intercepting the call and forwarding it to the call center.

A party placing a call of the sort discussed above to the one or more devices might, in various embodiments, be presented, perhaps via voice synthesis, with a welcome message. Moreover, in various embodiments a party placing a call of the sort discussed above to the one or more devices might receive a signal to begin speaking to the users that desire to receive calls from the party. The signal might, for instance, be a sound (e.g., a beep or chirp) and/or might be one or more words (e.g., words produced via voice synthesis). For example, the signal might be a voice saying “please start speaking to your fans now”. Such signal functionality might, in various embodiments, be employed to allow for time for users to answer placed calls and/or to be connected to the live call from the party.

The signal might, for instance, be presented in the case where certain conditions are met. For example, the signal might be presented after a certain period of time has elapsed (e.g., 10 seconds). Such a period of time might, for instance, begin with the one or more devices receiving the call from the party, with the one or more devices placing calls to one or more users that have indicated desire to receive calls from the party, and/or with one or more of those users answering such placed calls. As another example, the signal might, alternately or additionally, be presented after a certain number of and/or a certain percentage (e.g., 50%) of users have been connected to and/or are ready to be connected to the live call from the party.

A user connected to the live call from the party might, in various embodiments, might receive a signal before the party begins speaking. Such a signal might, for instance, be a sound (e.g., of the sort discussed above) and/or might be one or more words (e.g., words produced via voice synthesis). Such functionality might, for instance, be employed to help keep a called user on the line in the case where there will be a delay before the party begins speaking (e.g., a delay resulting from the party waiting for a signal of the sort discussed above).

The signal provided to the user might, for example, be an introductory message presented via voice. Such an introductory message might, for instance, be presented so as to sound like an assistant of the party, state words recognizing that the user has answered the call, and/or might state words indicating that the user should wait for the party. For example, in the case where the party was named “Ms. Example”, such a message might state:
“Great, I'm glad you're there. I have Ms. Example on the line to speak to you”.

It is noted that, in various embodiments, such functionality might be employed to simulate situations in which a person employs her assistant to make a call to someone, and only comes on the line once her assistant indicates that the target of the call has answered.

A party speaking on a live call to which one or more users are connected might, in her speaking, convey various information. For example, the party might discuss and/or advertise one or more, perhaps new, items, services, and/or offerings. As illustrative examples, the party might discuss and/or advertise one or more musical albums, one or more pieces of music, one or more films, one or more games, and/or financial information (e.g., quarterly results of a company).

It is noted that, in various embodiments, call placement to users might, for instance, involve the use of Global System for Mobile Communications (GSM), Universal Mobile Telecommunications Service (UMTS), Code Division Multiple Access 2000 (CDMA2000), and/or Voice over Internet Protocol (VOIP).

Additional Operations

Users that have indicated desire to receive live calls from one or more parties might, in various embodiments, receive one or more dispatches from those parties. Such dispatch might, for instance, be received by a user's telephone and/or wireless node and/or other computer. Such dispatches might, for instance, include links relating to items discussed during a call from a party and/or items discussed during a call from a party. Such items might, for example, include items of the sort discussed above (e.g., music, still images, and/or moving images). Such a link might, for instance, be a link to an online store from which an item discussed during a call from a party can be downloaded and/or purchased (e.g., via a GUI and/or other interface of a user telephone and/or wireless node and/or other computer). It is noted that, in various embodiments, dispatch might provide instructions and/or directions for visiting a physical location (e.g., a location where a party will be, where a party will give a concert, and/or a physical store at which an item discussed during a party call can be purchased).

It is noted that, in various embodiments an item (e.g., one discussed during a party call) might be dispatched (e.g., as part of a promotion). For example, in the case where a live call from a party discussed a new album, dispatched to users that had indicated a desire to receive live calls from the party might be a single track from the album and/or a link to an online store from which the entire album can be purchased and downloaded.

The functionality by which dispatch is performed might be implemented in a number of ways. For example, a party might indicate to one or more devices (e.g., one or more servers) one or more specifications regarding that which is to be dispatched. Such one or more devices might, in various embodiments, be devices that perform, and/or might be in communication with (e.g., in a manner analogous to that discussed above) one or more devices that perform, one or more of the operations discussed above. Such one or more devices might, in various embodiments, include and/or be in communication with call and/or messaging interface software and/or hardware of the sort discussed above.

Such indication might, for instance, be provided in a manner analogous to that discussed above (e.g., via GUI and/or other interface or via call). Such indication might, for instance, include item upload and/or link specification.

Dispatch in accordance with the party's indication might, for example, be performed by the one or more devices. Dispatch might, for instance, be via messaging of the sort discussed above (e.g., email, instant messaging, and/or MMS). The one or more devices might, in various embodiments, consult one or more accessible stores to learn of messaging addresses specified, perhaps as discussed above, by users that desire to receive calls from the party as being messaging addresses to which dispatches from the party should be directed.

Dispatch might be performed at one or more times. For example, the one or more devices might perform dispatch during a live call from a party. As another example, the one or more devices might perform dispatch after and/or before a live call from a party. Parties might, in various embodiments, be able to specify when dispatch should take place. Such specification might, for instance, be in a manner analogous to that discussed above.

As an illustrative example, a party, prior to acting to place a live call to one or more users that have indicated desire to receive calls from her, might specify to the one or more devices a movie trailer for a new movie of hers as an item to be dispatched to the users during the call. The party might then, during the live call to the users, discuss her new movie, and the one or more devices might, in accordance with the party's request, dispatch the movie trailer to the users while the call is taking place.

As another illustrative example, a party (e.g., a corporate leader), prior to acting to place a live call to one or more users that have indicated desire to receive calls from her, might specify to the one or more devices data relating to quarterly results of a company as one or more items to be dispatched to users during the call. The party might then, during the live call to the users, discuss the quarterly results, and the one or more devices might, in accordance with the party's request, dispatch the data to the users while the call is taking place.

As noted above, in various embodiments one or more devices might place calls to users and connect a user answering such a call to a live call from a party. According to various embodiments of the present invention, functionality might be provided to deal with scenarios in which users fail to answer such calls.

For example, functionality might be provided wherein a message (e.g., a voice message and/or text message) is, perhaps by the action of one or more devices (e.g., one or more servers), left for a user so missing such a call. Such one or more devices might, in various embodiments, be devices that perform, and/or might be in communication with (e.g., in a manner analogous to that discussed above) one or more devices that perform, one or more of the operations discussed above. Such one or more devices might, in various embodiments, include and/or be in communication with call and/or messaging interface software and/or hardware of the sort discussed above.

Such a voice message and/or text message might, for example, be one pre-formulated (e.g., pre-recorded) by the party whose live call the user would have been connected to had she answered the missed call. For instance, the party might pre-record a voice message apologizing for missing the user, providing information regarding the content of the missed call (e.g., providing information about a item that was discussed during the call), and/or encouraging the user to perform one or more actions (e.g., visiting a website, visiting a physical location, and/or coming to possess an item such as one discussed during the call).

To illustrate by way of example, in the case where the party was to place a live call to users discussing her new album, she might pre-record such a voice message, the voice message stating:

“Sorry that I missed you. I just wanted to tell you about my new album. Check for it at your local record shop”.

As another example, the user might be provided with a message (e.g., a voice message) containing the some or all of content of the call from the party. For instance, the user might receive a message containing the call from the party in its entirety.

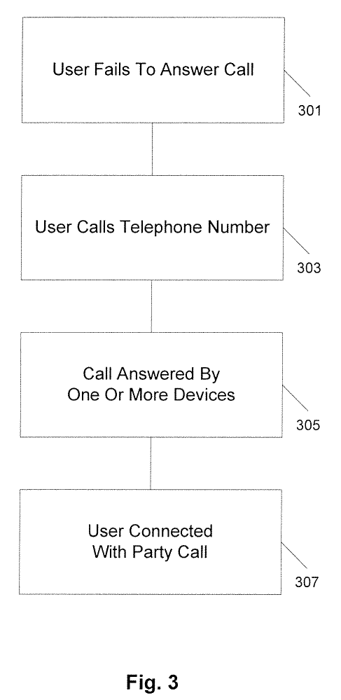

With respect to FIG. 3 it is noted that, as another example of functionality provided to deal with scenarios in which a user fails to answer a call placed to connect answering users with a live call from a party (step 301), functionality might be provided wherein such a user can be connected to the party call. For instance, the user might be able to employ her phone and/or wireless node and/or other computer to call a telephone number in order to be connected to the party call (step 303). The telephone number called by the user might, for instance, be a telephone number established to be called by users that have so missed a call placed to connect users with a party call and/or might be a telephone number provided to the user at the time that the user, perhaps as discussed above, indicated a desire to receive live calls from one or more parties.

The call placed by the user seeking to be connected to the party call might, for instance, be answered by one or more devices (e.g., one or more servers) (step 305). Such one or more devices might, in various embodiments, be devices that perform, and/or might be in communication with (e.g., in a manner analogous to that discussed above) one or more devices that perform, one or more of the operations discussed above. Such one or more devices might, in various embodiments, include and/or be in communication with call and/or messaging interface software and/or hardware of the sort discussed above.

The one or more devices answering the call from the user might, in various embodiments, act to connect the user with the party call (step 307). The one or more devices might, for instance, perform such connection in a manner analogous to that discussed above. The one or more devices might, for example, establish a telephonic audio link between the party and the user. It is noted that, in various embodiments, the party call might already be in progress.

According to various embodiments of the present invention, a user may be able to set various preferences regarding calls from parties. For example, the user might be able to set ringer preferences regarding calls from parties. For instance, the user might be able to set calls from parties to ring with or without vibration, at one or more volumes (e.g., including silence), and/or with one or more ringtones. As another example, the user might be able to set preferences allowing and/or denying calls from parties for certain time periods. As illustrative examples, the user might choose to deny calls from parties while she is sleeping and/or while she is at work. Denied calls might, in various embodiments, be directed to the user's voicemail. As yet another example, the user might be able to set preferences regarding whether or not she wishes to receive messages (e.g., of the sort discussed above) in the case where she misses a party call. Preferences might, for instance, be settable via one or more GUIs and/or other interfaces.

It is noted that users might, in various embodiments be able to set preferences regarding party calls via one or more profiles. Moreover, in various embodiments preferences regarding party calls might be settable with and/or apart from settings regarding other calls.

In various embodiments, one or more accessible stores discussed herein might include one or more databases. Moreover, various of the devices (e.g., servers) and/or online stores discussed herein might, in various embodiments, be owned and/or operated by one or more service providers, content providers (e.g., record companies, television studios, and/or movie studios), parties, and/or manufactures (e.g., device manufacturers).

Parties might, according to various embodiments of the present invention, produce content and/or make calls to interested users, and/or might receive monetary reward directly and/or from service providers and/or content providers. Such monetary reward might, for instance, reflect content sales. Service providers might, in various embodiments, act to enable party call functionality and/or to provide network bandwidth, and/or might receive monetary reward directly (e.g., via content sales and/or network use) and/or from content providers and/or parties. For example, in various embodiments a service provider might count how many users have answered a call and employ this value in determining how much to charge corresponding content providers and/or parties for the call.

Manufacturers (e.g., device manufacturers) might, in various embodiments, act to enable party call functionality, and/or might receive monetary reward via device sales. Content providers might, in various embodiments, provide advertising for parties and/or might receive monetary reward from content sales.

It is further noted that, in various embodiments, one or more parties might act to license, provide, and/or sell various party call aspects discussed herein to one or more other parties (e.g., parties, service providers, content providers, and/or manufacturers), and/or might receive monetary reward for doing so.

It is noted that, in various embodiments, calls might, for example, discuss and/or advertise items, services, and/or offerings. It is further noted that, in various embodiments, a user might be able to receive a call from multiple parties and/or a group of parties (e.g., a band or a comedy group. It is additionally noted that, in various embodiments, various functionality discussed herein might be employed by organizations (e.g., corporations).

Hardware and Software

Various operations and/or the like described herein may, in various embodiments, be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, telephone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal sever, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

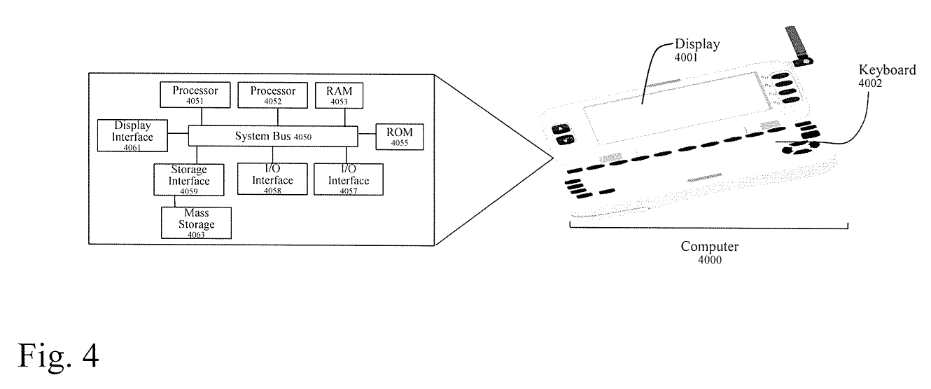

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 4 is an exemplary computer employable in various embodiments of the present invention. Exemplary computer 4000 includes system bus 4050 which operatively connects two processors 4051 and 4052, random access memory 4053, read-only memory 4055, input output (I/O) interfaces 4057 and 4058, storage interface 4059, and display interface 4061. Storage interface 4059 in turn connects to mass storage 4063. Each of I/O interfaces 4057 and 4058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee (e.g., IEEE 802.15.4), Bluetooth, Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 4063 may be a hard drive, optical drive, a memory chip, or the like. Processors 4051 and 4052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, an Intel Core, or an IBM, Toshiba, or Sony Cell processor. Computer 4000 as shown in this example also includes a touch screen 4001 and a keyboard 4002. In various embodiments, a mouse, keypad, and/or interface might alternately or additionally be employed. Computer 4000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

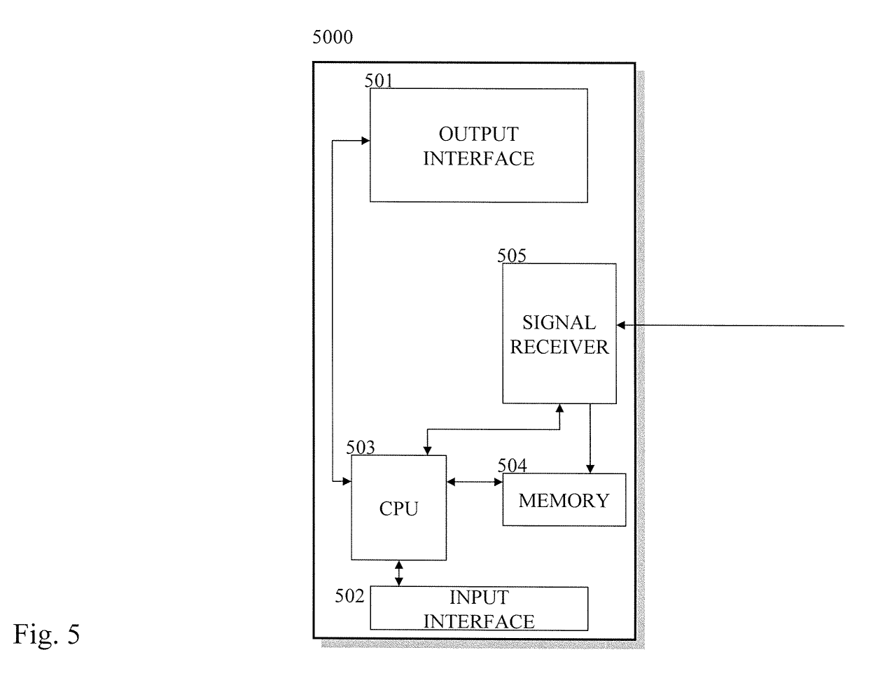

Shown in FIG. 5 is a block diagram of a terminal, an exemplary computer employable in various embodiments of the present invention. In the following, corresponding reference signs are applied to corresponding parts. Exemplary terminal 5000 of FIG. 5 comprises a processing unit CPU 503, a signal receiver 505, and a user interface (501, 502). Signal receiver 505 may, for example, be a single-carrier or multi-carrier receiver. Signal receiver 505 and the user interface (501, 502) are coupled with the processing unit CPU 503. One or more direct memory access (DMA) channels may exist between multi-carrier signal terminal part 505 and memory 504. The user interface (501, 502) comprises a display and a keyboard to enable a user to use the terminal 5000. In addition, the user interface (501, 502) comprises a microphone and a speaker for receiving and producing audio signals. The user interface (501, 502) may also comprise voice recognition (not shown).

The processing unit CPU 503 comprises a microprocessor (not shown), memory 504 and possibly software. The software can be stored in the memory 504. The microprocessor controls, on the basis of the software, the operation of the terminal 5000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 5, alternatively, middleware or software implementation can be applied. The terminal 5000 can, for instance, be a hand-held device which a user can comfortably carry. The terminal 5000 can, for example, be a cellular mobile phone which comprises the multi-carrier signal terminal part 505 for receiving multicast transmission streams. Therefore, the terminal 5000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
receiving a call from a party;
determining one or more users interested in receiving calls from the party; and
connecting one or more of the users with a live one-way call from the party.

2. The method of claim 1, wherein the party is one or more of a celebrity, a musician, an actor, an athlete, a writer, a director, an artist, a host, a corporate leader, and an advertiser.

3. The method of claim 1, further comprising dispatching, to one or more of the users, one or more links to one or more sources of one or more items during the live one-way call.

4. The method of claim 1, further comprising dispatching, to one or more of the users, one or more items during the live one-way call.

5. The method of claim 1, further comprising providing to the party a signal to begin speaking.

6. The method of claim 1, further comprising providing, to one or more of the users, caller identification corresponding to the party.

7. The method of claim 6, wherein a call placed to a phone number indicated by the caller identification is directed to a call center.

8. The method of claim 1, further comprising:
receiving a call from a user; and
connecting the user with the live one-way call,
wherein the user missed a call placed to connect the user with the live one-way call.

9. The method of claim 1, further comprising presenting to one or more of the users a message, wherein the message is played prior to a time the party begins speaking.

10. The method of claim 1, further comprising leaving a voice message for a user, wherein the user missed a call placed to connect the user with the live one-way call.

11. A method, comprising:
indicating a desire to receive calls from a party; and
receiving a call providing connection to a live one-way call from the party,
wherein the party places a call to one or more devices that determine one or more users interested in receiving calls from the party.

12. The method of claim 11, wherein the party is one or more of a celebrity, a musician, an actor, an athlete, a writer, a director, an artist, a host, a corporate leader, and an advertiser.

13. The method of claim 11, further comprising receiving one or more links to one or more sources of one or more items during the live one-way call.

14. The method of claim 11, further comprising receiving one or more items during the live one-way call.

15. The method of claim 11, wherein the one or more devices provide to the party a signal to begin speaking.

16. The method of claim 11, further comprising receiving caller identification corresponding to the party.

17. The method of claim 16, further comprising placing a call to a phone number indicated by the caller identification, wherein the call placed to the indicated phone number is directed to a call center.

18. The method of claim 11, further comprising:
placing a call to one or more of the devices; and
receiving connection to the live one-way call,
wherein the received call is missed.

19. The method of claim 11, further comprising receiving a message, wherein the message is played prior to a time the party begins speaking.

20. The method of claim 11, further comprising receiving a voice message, wherein the received call is missed.

21. A system, comprising:
a memory having program code stored therein; and
a processor disposed in communication with the memory for carrying out instructions in accordance with the stored program code;
wherein the program code, when executed by the processor, causes the processor to perform:
receiving a call from a party;
determining one or more users interested in receiving calls from the party; and
connecting one or more of the users with a live one-way call from the party.

22. The system of claim 21, wherein the party is one or more of a celebrity, a musician, an actor, an athlete, a writer, a director, an artist, a host, a corporate leader, and an advertiser.

23. The system of claim 21, wherein the processor further performs dispatching, to one or more of the users, one or more links to one or more sources of one or more items during the live one-way call.

24. The system of claim 21, wherein the processor further performs dispatching, to one or more of the users, one or more items during the live one-way call.

25. The system of claim 21, wherein the processor further performs providing to the party a signal to begin speaking.

26. The system of claim 21, wherein the processor further performs providing, to one or more of the users, caller identification corresponding to the party.

27. The system of claim 26, wherein a call placed to a phone number indicated by the caller identification is directed to a call center.

28. The system of claim 21, wherein the processor further performs:
receiving a call from a user; and
connecting the user with the live one-way call,
wherein the user missed a call placed to connect the user with the live one-way call.

29. The system of claim 21, wherein the processor further performs presenting to one or more of the users a message, wherein the message is played prior to a time the party begins speaking.

30. The system of claim 21, wherein the processor further performs leaving a voice message for a user, wherein the user missed a call placed to connect the user with the live one-way call.

31. A system, comprising:
a memory having program code stored therein; and
a processor disposed in communication with the memory for carrying out instructions in accordance with the stored program code;
wherein the program code, when executed by the processor, causes the processor to perform:
indicating a desire to receive calls from a party; and
receiving a call providing connection to a live one-way call from the party,
wherein the party places a call to one or more devices that determine one or more users interested in receiving calls from the party.

32. The system of claim 31, wherein the party is one or more of a celebrity, a musician, an actor, an athlete, a writer, a director, an artist, a host, a corporate leader, and an advertiser.

33. The system of claim 31, wherein the processor further performs receiving one or more links to one or more sources of one or more items during the live one-way call.

34. The system of claim 31, wherein the processor further performs receiving one or more items during the live one-way call.

35. The system of claim 31, wherein the one or more devices provide to the party a signal to begin speaking.

36. The system of claim 31, wherein the processor further performs receiving caller identification corresponding to the party.

37. The system of claim 36, wherein the processor further performs placing a call to a phone number indicated by the caller identification, wherein the call placed to the indicated phone number is directed to a call center.

38. The system of claim 31, wherein the processor further performs:
placing a call to one or more of the devices; and
receiving connection to the live one-way call,
wherein the received call is missed.

39. The system of claim 31, wherein the processor further performs receiving a message, wherein the message is played prior to a time the party begins speaking.

40. The system of claim 31, wherein the processor further performs receiving a voice message, wherein the received call is missed.

41. A device, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
receiving a call from a party;
determining one or more users interested in receiving calls from the party; and
connecting one or more of the users with a live one-way call from the party.

42. A wireless node, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
indicating a desire to receive calls from a party; and
receiving a call providing connection to a live one-way call from the party,
wherein the party places a call to one or more devices that determine one or more users interested in receiving calls from the party.

43. An article of manufacture comprising a computer readable medium containing program code that when executed causes a device to perform:
receiving a call from a party;
determining one or more users interested in receiving calls from the party; and
connecting one or more of the users with a live one-way call from the party.

44. An article of manufacture comprising a computer readable medium containing program code that when executed causes a wireless node to perform:
indicating a desire to receive calls from a party; and
receiving a call providing connection to a live one-way call from the party,
wherein the party places a call to one or more devices that determine one or more users interested in receiving calls from the party.
